(19) United States
(12) Patent Application Publication
(10) Pub. No.: US 2010/0170876 A1
(43) Pub. Date: Jul. 8, 2010

(54) CIRCUIT BREAKER WITH SWITCHING GAS COOLING

(76) Inventors: Michael Bach, Berlin (DE); Werner Hartmann, Weisendorf (DE); Detlev Schmidt, Berlin (DE); Günter Seidler, Berlin (DE); Sezai Türkmen, Berlin (DE); Artur Wajnberg, Berlin (DE)

Correspondence Address: King & Spalding LLP, 401 Congress Avenue, Suite 3200, Austin, TX, 78701, US

(21) Appl. No.: 12/664,020

(22) PCT Filed: May 28, 2008
(86) PCT No.: PCT/EP08/56552

§ 371 Date: Dec. 10, 2009

(30) Foreign Application Priority Data
Jun. 15, 2007 (DE) 10 2007 028 204.6

(51) Int. Cl. H01H 33/53; H01H 11/00

(52) U.S. Cl. 218/157; 29/622; 29/428

(57) ABSTRACT

A circuit breaker has at least one housing having at least one opening, and at least one pair of contacts located in the housing, the contacts of the pair of contacts being mobile in relation to each other for opening and closing an electric circuit. An open-pore metal foam (20) is interposed between at least one of the pairs of contacts and at least one housing opening (11), the metal foam being electrically insulated from the current-carrying elements of the circuit breaker (1). An open-pore metal foam (20), produced of a zinc base alloy or aluminum base alloy, can be used as a cooling structure for the dissipation of heat from switching gases that are produced by an electric switching process.

### CROSS-REFERENCE TO RELATED APPLICATIONS

This application is a U.S. National Stage Application of International Application No. PCT/EP2008/056552 filed May 28, 2008, which designates the United States of America, and claims priority to German Application No. 10 2007 028 204.6 filed Jun. 15, 2007, the contents of which are hereby incorporated by reference in their entirety.

### TECHNICAL FIELD

The invention relates to a circuit breaker having a housing which has at least one opening and having at least one contact pair which are arranged in the housing, with the contacts of the contact pair being movable relative to one another in order to open and close a circuit.

### BACKGROUND

Electromechanical switching devices which are arranged for power distribution in voltage power supply systems limit or open the current flow in the power supply system. In order to limit the current flow, the metallic contacts which are arranged to form a contact pair are disconnected from one another, with an arc being produced between the two contacts and having a burning voltage in the order of magnitude of the driving voltage in the power supply system. Surface particles which are burnt off the contact surfaces result in a hot ionized gas which expands because of the temperature increase and thus also heats adjacent gas layers and surfaces. The expansion of the hot switching gas results in a risk of damage to the switch housing as a result of an excessive increase in the internal pressure, and the flow of the hot switching gas out of the housing results in a risk of excessive heating of installations which are located in the immediate vicinity of the circuit breaker, or a risk to the health of people located in the vicinity of the circuit breaker. The ion content of the gas likewise results in a risk of shorts being formed between surrounding live parts in a switchgear assembly.

Single-layer or multilayer metallic gratings composed of wire meshes or perforated metal sheets and stacks of metal sheets kept at a distance apart are normally used to cool down, and therefore to deionize, the switching gases. In this case, the metal sheets are generally composed of steel or copper, or of corresponding alloys. The use of the metal sheets or meshes that are used results in the gas which is adjacent to the surfaces of the metal sheets emitting its heat to the metal sheets. The metal sheets must have good thermal conductivity and a high melting point, for this purpose. Copper has good thermal conductivity, but a low melting point. Steel has low thermal conductivity, but in exchange has a high melting point. This means that neither of the two materials which are normally used can interact optimally with the switching gas to be cooled down. Furthermore, for effective heat transmission from the switching gas to the metal sheets, it is necessary for a large surface area of the metal sheets to be in contact with the hot switching gas. The flow resistance on or between the metal sheets should in this case be low, in order to achieve rapid gas dissipation.

Since thermal energy is extracted from the hot switching gas by means of the perforated metal sheets or metallic gratings, the temperature of the switching gases decreases, thus reducing the energy of the particles of the switching gases, and deionizing the switching gas.

A described arrangement of components such as this for heat extraction from switching gases is illustrated in FIGS. 1 and 2.

FIG. 1 shows an exploded illustration of the design of a conventional circuit breaker which is suitable for cooling down switching gases. This circuit breaker has quenching plates 30 which are arranged parallel to one another and running at right angles to a perforated metal sheet 40. The quenching plates 30 in this case do not rest directly on the perforated metal sheet 40 but are positioned at a distance from it or are electrically isolated from it, such that no current can flow between the quenching plates 30 and the perforated metal sheet 40. A sieve 50 on which a cover 16 which has openings 11 rests is located at a distance from the perforated metal sheet 40. A sieve such as this can also be in the form of a metallic grating. Front walls and rear walls 13 as well as side walls 14 and cover plates 15 form the housing 10 of the circuit breaker.

As can be seen in particular from FIG. 2, switching gases which are produced in the switching area 12 of the circuit breaker 1 can propagate between the quenching plates 30 and can pass through openings, which are provided in the perforated metal sheet 40, into the area between the perforated metal sheet 40 and the sieve 50. From there, the switching gases flow through the metallic sieve 50 and the openings 11 in the cover 16 into the surrounding area of the circuit breaker. Thermal energy is extracted from the switching gas, and the gas is in consequence deionized, by the contact between the switching gas and the surfaces of the perforated metal sheet, the sieve and the cover. The embodiments described so far for gas cooling have the disadvantage that a multiplicity of different components must be produced and installed in a circuit breaker. The effort for the production and fitting of these components has a disadvantageous effect on the production price of the circuit breaker.

EP 1 229 609 A1 discloses a cable plug connection in which a metallic foam part is integrated. In this case, the metallic foam part is arranged in the one female half of the plug connection such that it is in contact with a live part of the plug connection half. When the plug connection is closed, it is likewise in contact with a live part of the male half of the plug connection. This means that the metallic foam part allows current to flow from the male half of the plug connection into the female half of the plug connection. In particular, the metallic foam part is used to maintain a current flow between the two plug connection halves for as long as possible when the live part of the male plug connection half is removed from the female plug connection half, so as to prevent arc formation between the two plug connection halves.

### SUMMARY

According to various embodiments, an open circuit breaker can be provided with a simple and low-cost physical design, by means of which the risk of damage to the circuit breaker and components surrounding it, and the risk to personnel, can reliably be avoided.

According to an embodiment, a circuit breaker may have a housing which has at least one opening and having at least one contact pair which are arranged in the housing, with the contacts of the contact pair being movable relative to one another in order to open and close a circuit, and an open-pore metal foam, which is electrically isolated from the live parts of the circuit breaker, which is arranged between at least one of the contact pairs and at least one housing opening.

According to a further embodiment, quenching plates, on which the metal foam is supported on one side, can be arranged in the housing of the circuit breaker. According to a further embodiment, furthermore at least one perforated metal sheet and/or at least one sieve can be arranged between the contact pair and the housing opening between which the open-pore metal foam is arranged, in order to reduce the heat of the switching gas. According to a further embodiment, the metal foam can be at least partially connected to the housing and/or to the perforated metal sheet by means of an adhesive connection. According to a further embodiment, the metal foam can be at least partially connected to the housing and/or to the perforated metal sheet by means of a welded or soldered connection. According to a further embodiment, the metal foam can be at least partially connected to the housing and/or to the perforated metal sheet by means of force-fitting clamping. According to a further embodiment, the metal foam may form a part of the housing surface in the area of the housing opening. According to a further embodiment, the metal foam which is used can be composed of an aluminum-based alloy. According to a further embodiment, the metal foam which is used can be composed of a zinc-based alloy.

According to another embodiment, an open-pore metal foam based on a zinc alloy or aluminum alloy can be used as a cooling structure for heat dissipation from switching gases which are created in an electrical switching process.

### BRIEF DESCRIPTION OF THE DRAWINGS

The present invention will be explained with reference to the attached drawings, in which:

FIG. 1 shows an exploded illustration of a conventional circuit breaker which is designed for cooling switching gases;

FIG. 2 shows a section view from the front of the conventional circuit breaker designed for cooling switching gases;

FIG. 3 shows a section view from the front of a circuit breaker according to an embodiment, and

FIG. 4 shows an enlarged schematic illustration of the metal foam which is used in the circuit breaker according to an embodiment.

### DETAILED DESCRIPTION

A circuit breaker is provided having a housing which has at least one opening and having at least one contact pair which are arranged in the housing, wherein the contacts of the contact pair can move relative to one another in order to open and close a circuit, wherein an open-pore metal foam, which is electrically isolated from the live parts of the circuit breaker, is arranged between at least one of the contact pairs and at least one housing opening. The contacts of the contact pair are in this case advantageously arranged such that one of the contacts is a fixed contact, and the other contact is a moving contact. In addition to the opening in the housing, which is largely sealed by the open-pore metal foam, the housing may also have further openings. The housing and the entire internal area of the circuit breaker should, however, be designed such that the majority of the switching gases which are created are passed out of the switching area, in which the arc is created, through the metal foam, out of the interior of the circuit breaker into its surrounding area. The further openings in the housing of the circuit breaker may, for example, be arranged for cables to pass through, for other ventilation purposes, or for installation purposes.

When the contacts open, an arc is struck between them, which results in surface particles being melted off the contacts. The surface particles which have been melted off together with the heated air from the area surrounding the arc form a switching gas cloud, whose volume expands because of the heating. The metal foam is designed to have open pores, that is to say individual pores or capillaries which extend into the internal area of the foam, are open on the surface of the foam and are connected to one another such that a volume flow can be produced through the foam. As the volume of the heated switching gas expands and the pressure in the interior of the switch housing thus increases, the switching gas is passed through the open-pore metal foam to the outside of the switch housing. The hot switching gas flows through the pores or capillaries, which are connected to one another, in the metal foam. Since the metal foam forms a very large surface area, it is possible to bring a large surface area into contact with the hot switching gas. Even if the open-pore metal foam has thin walls, this results in effective heat transmission from the switching gas to the metal foam. After the switching gas has emerged from the metal foam on the outside of the switch housing, the latter is at a reduced temperature such that the particles which form the switching gas are no longer in the form of ions, but are atoms. This largely precludes the risk of damage and danger to installations or people in the vicinity of the circuit breaker, because the temperature is reduced. The deionization of the switching gas likewise prevents shorts from being formed by the switching gas on its surrounding live switchgear assembly parts. Further advantages of the arrangement of the metal foam in the circuit breaker are that matching to existing circuit breaker parameters and/or arc parameters can be achieved in a simple manner by variations of the geometry, of the density and of the cell structure of the metal foam that is used. Furthermore, in comparison to the conventional embodiments which are produced using a multiplicity of components, the assembly effort is considerably reduced by the use of only one metal foam block or metal foam wall. Metal foam blocks or metal foam walls such as these can be processed in a simple manner to their final size by sawing or other typical metalworking methods.

In one advantageous embodiment, the circuit breaker is designed such that quenching plates are arranged in the housing of the circuit breaker, on which the metal foam is supported on one side. These quenching plates are used in the normal manner to quench the arc which is struck between the contacts after they have been opened. However, when quenching plates are used, the metal foam must not rest directly on them, in order to ensure that the quenching plates are not electrically connected to one another. However, it is also possible to provide for the metal foam to be supported on one or more isolating layers, which are in turn supported on the end faces of the quenching plates. In this case, it is advantageous to use a point contact with the metal foam, in order to prevent continuous pinching of pores and capillaries in the metal foam by the metal foam being pushed in leading to an increase in the flow resistance in the metal foam.

According to an embodiment, furthermore at least one perforated metal sheet and/or at least one sieve are/is arranged between the contact pair and the housing opening between which the open-pore metal foam is arranged, in order to reduce the heat of the switching gas. In this case, the perforated metal sheet and the sieve are likewise used to cool down the switching gas, by absorbing heat from the switching gas. In this case, the perforated metal sheet can likewise be used as a support for the metal foam on its side facing away from the quenching plates. This means, in this refinement, the metal foam is not supported directly on the edges of the quenching plates or on an isolating layer that is fitted to these edges, but that a perforated metal sheet is located between the metal foam and the quenching plates, through which the gases which flow through between the quenching plates can be introduced into the metal foam.

A further embodiment provides that the metal foam is at least partially connected to the housing and/or to the perforated metal sheet by means of an adhesive connection. If the isolation capability of the adhesive connection is adequate, the metal foam can also be firmly adhesively connected to the end faces of the quenching plates, but in this case the possibility of current flowing via the metal foam must be precluded. Instead of an adhesive connection, it is also possible to use a welded connection and/or soldered connection between the metal foam and the housing or the perforated metal sheet. This means that, for example, the metal foam can be connected on one side of its surface to a perforated metal sheet by means of an adhesive connection and, furthermore, may be welded to the housing, for example.

One alternative refinement provides that the metal foam is at least partially connected to the housing and/or to the perforated metal sheet by means of force-fitting clamping. The metal foam can also be clamped between the housing and the quenching plates when an isolating layer is arranged between these components.

This therefore results in a circuit breaker having a housing which has at least one opening and having at least one contact pair which are arranged in the housing, in which the contacts of the contact pair can move relative to one another in order to open and close a circuit, wherein an open-pore metal foam, which is electrically isolated from the live parts of the circuit breaker, is arranged between at least one of the contact pairs and at least one housing opening, and wherein the metal foam is at least partially connected to the housing and/or to the perforated metal sheet by means of force-fitting clamping.

This means that, when the foam is fitted into the switch, the foam is placed in a somewhat compressed form into its final position in the inner housing of the switch and, because of its elasticity, expands there such that it holds itself firmly in a force-fitting manner on the inside of the housing and/or on the quenching plate by virtue of the friction forces acting as a result of the spring force. In this refinement as well, it is advantageous for the metal foam to make contact with the switch parts that surround it only at points, in order to reduce or to prevent closing or a reduction in the cross section of the pores and/or capillaries in the metal foam.

According to an embodiment, the metal foam is arranged in the area of the housing opening such that it itself forms a part of the housing surface.

This therefore provides a circuit breaker having a housing which has at least one opening and having at least one contact pair, which are arranged in the housing, in which the contacts of the contact pair can move relative to one another in order to open and close a circuit, wherein an open-pore metal foam, which is electrically isolated from the live parts of the circuit breaker, is arranged between at least one of the contact pairs and at least one housing opening, and this metal foam is arranged in the area of the housing opening such that it itself forms a part of the housing surface.

This means that the housing may have an opening for switching gas dissipation which is sufficiently large that a portion of the housing surface is formed by the metal foam itself. In this case, the housing does not have a gas dissipation channel behind the metal foam in the gas outlet-flow direction, but is designed to be open in this area.

In an alternative refinement to this, the switch housing has a gas dissipation channel behind the metal foam in the gas outlet-flow direction, for gas dissipation into the air surrounding the switch. In this refinement, the metal foam does not form a surface of the switch housing.

The metal foam which is used is advantageously composed of an aluminum-based alloy. In particular, metal foam composed of aluminum-based alloys, such as those which have been developed and are used for mechanical stiffening of components which consume energy in automobile and machine construction, can be used as a heat-absorbent switch part for the purposes of the invention. These metal foams can be produced in large quantities at low cost, and with defined characteristics such as porosity, density and external dimensions, using simple methods.

As an alternative to this, it is also possible to use metal foam composed of a zinc-based alloy.

The various embodiments therefore essentially comprise the use of an open-pore metal foam composed of a zinc-based alloy or aluminum-based alloy as a cooling structure for heat dissipation from switching gases which are created in electrical switching processes. The heat dissipation is in this case achieved in that heated switching gas is passed through the metal foam, with thermal energy being emitted from the switching gas to the metal structure, as a result of which the switching gas is at a considerably lower temperature after leaving the metal foam.

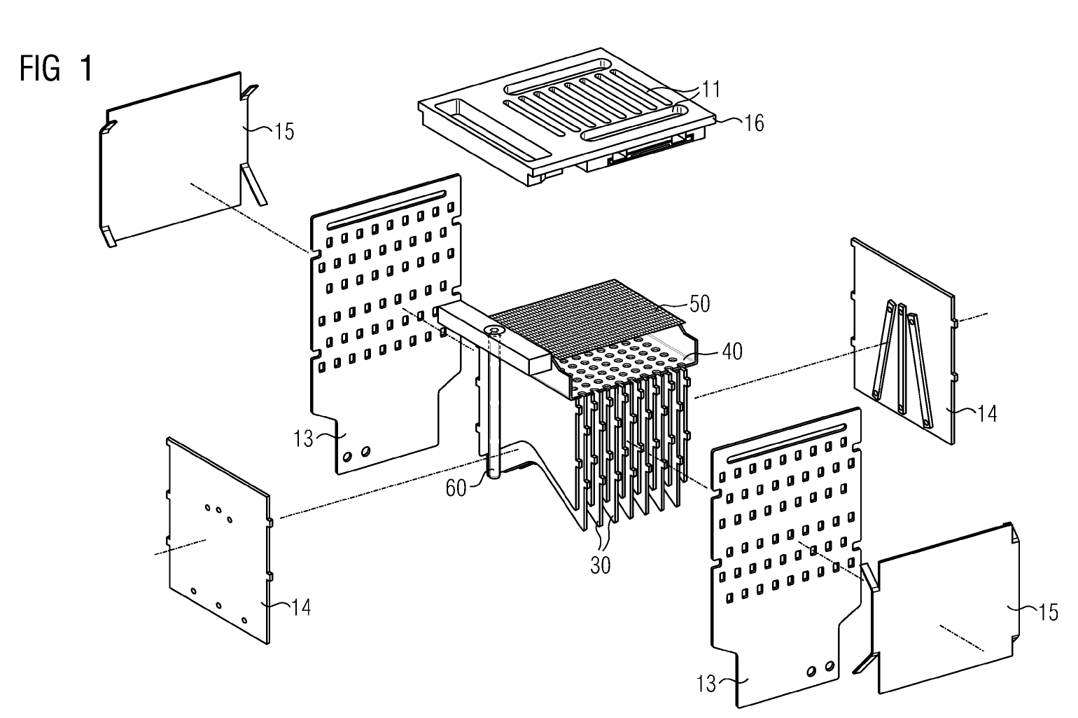

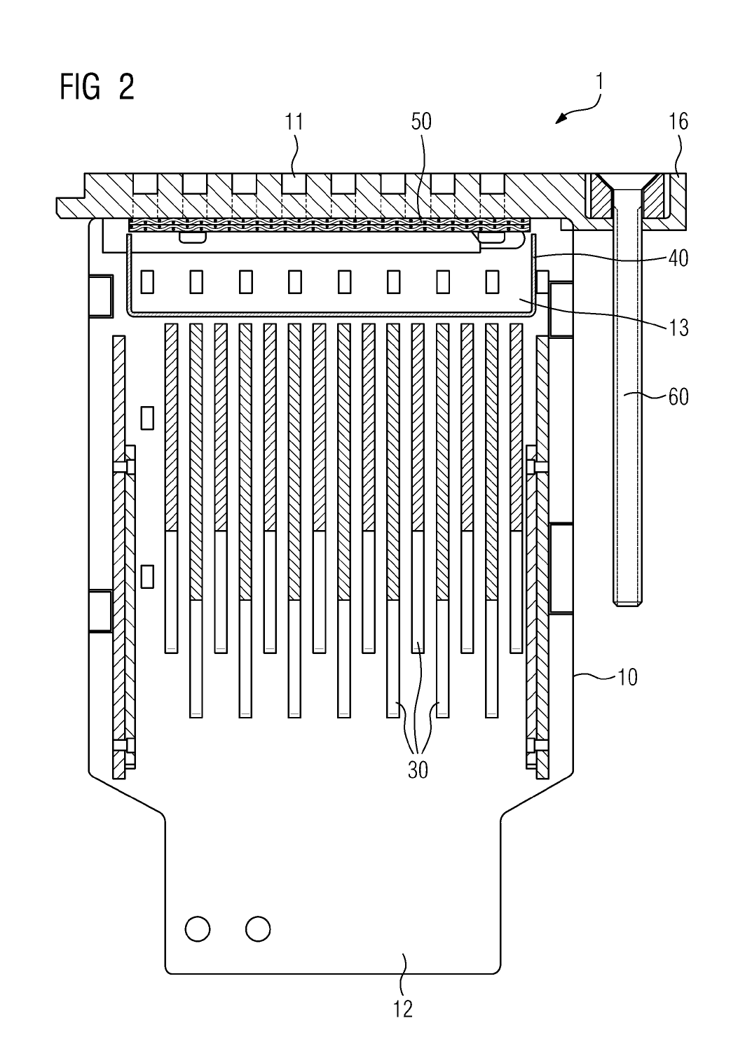

Reference has already been made to the conventional circuit breaker, as illustrated in FIGS. 1 and 2, in the description of the prior art.

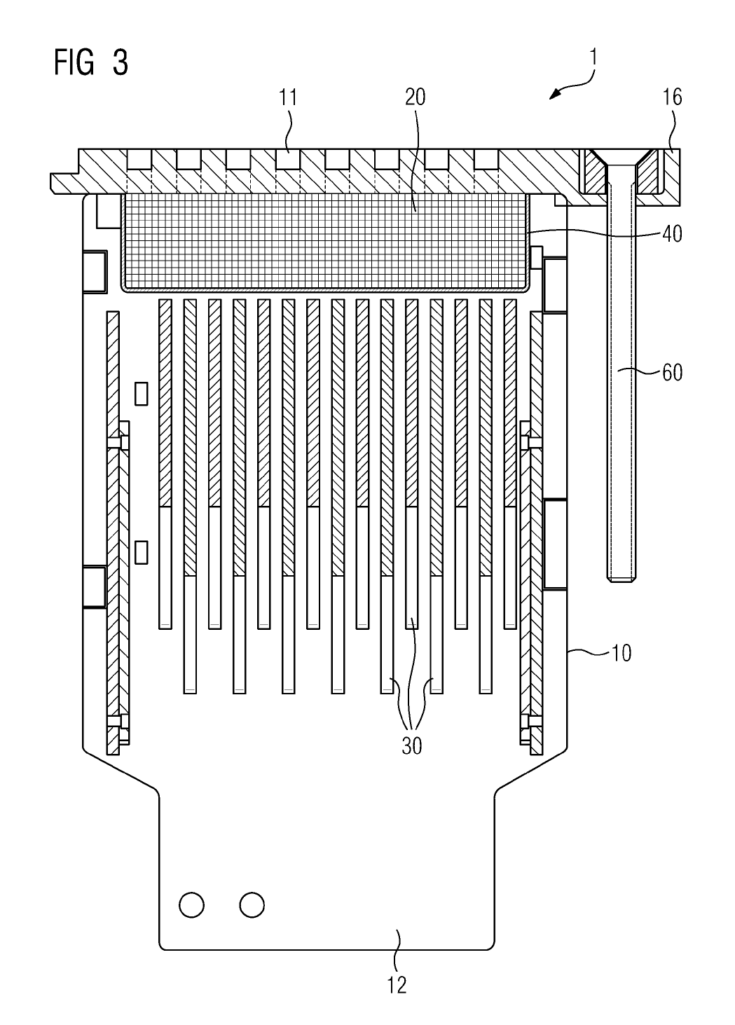

The external dimensions of the embodiment of the circuit breaker 1 according to an embodiment as illustrated in FIG. 3 are essentially defined by the housing 10 and the cover 16 which is attached to it, in which case the cover 16 can be regarded as a part of the housing which forms the surface of the circuit breaker. The entire housing 10 is mounted in a switchgear assembly, for example, via the cover 16 by means of an attachment bolt 60.

The switching area 12 is formed in the housing 10 of the circuit breaker 1, and the contacts (which are not illustrated) which can move relative to one another of the circuit breaker 1 are arranged in this switching area 12. A multiplicity of quenching plates 30 are located, arranged parallel to one another, above the switching area 12 and are used to reduce the effect of an arc which is struck between the contacts when they open. The perforated metal sheet 40, which has openings through it, is located above the upper edge of the quenching plates 30. The openings through the perforated metal sheet 40 are in this case arranged as illustrated in FIG. 1. The metal foam 20 is located between the cover 16 and the perforated metal sheet 40. The cover 16 has a plurality of openings 11.

As has already been described with reference to the prior art, an arc is struck between the contacts in the switching area 12 when the contacts of the contact pair are opened. This arc leads to severe heating and ionization of the gas surrounding it. The severe heating of the gas in turn results in its volume being increased, and therefore in expansion of the heated gas. The expanding and flowing gas flows along between the quenching plates 30 to the perforated metal sheet 40. It passes through the through-openings in the perforated metal sheet 40 and thus enters the open pores or capillaries of the metal foam 20 that is provided according to an embodiment. Because of the high pressure in the interior of the switch housing 10, the heated gas is forced through the metal foam 20, as a result of which it arrives in a cooled-down form and deionized, through the openings 11 in the cover 16, in the area surrounding the circuit breaker 1. At this point, the gas is at a temperature which is not hazardous to surrounding installations or people. Furthermore, it is ionized by the cooling-down process so as to prevent shorts being formed between live line parts surrounding the circuit breakers.

In this case, the circuit breaker 1 which is provided according to an embodiment with metal foam 20 need not necessarily be in the form illustrated in FIG. 3 and, instead, it is alternatively possible to provide for no perforated metal sheet 40 to be arranged between the quenching plates 30 and the metal foam 20. It is likewise alternatively possible to provide for one surface of the metal foam 20 to form a part of the overall surface of the circuit breaker 1. In this embodiment, the circuit breaker 1 does not have a cover 16 in the area of the metal foam 20, or has a cover 16 with a large opening 11 corresponding to that surface of the metal foam 20 but faces outward. An embodiment is likewise feasible in which no quenching plates 30 are arranged in the switching area 12 or adjacent to it. In an embodiment such as this, the switching gases produced by the arc flow directly through the perforated metal sheet 40 or, in its absence, directly into the metal foam 20 and from there into the air surrounding the circuit breaker 1.

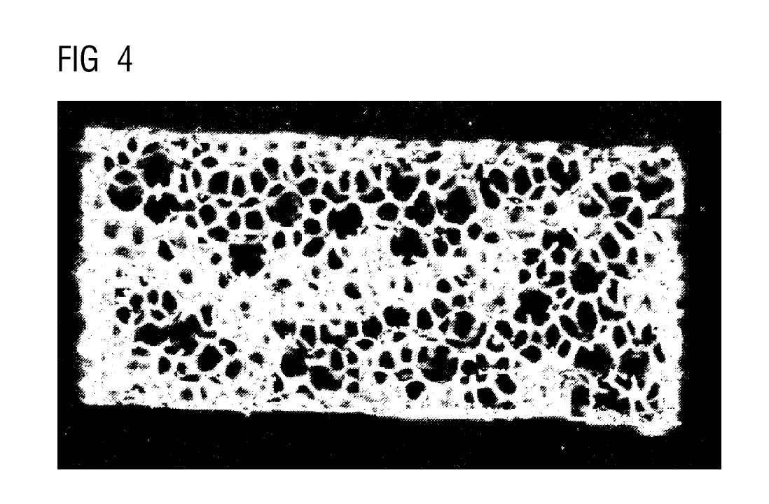

FIG. 4 shows an enlarged, schematic illustration of a section area of the metal foam 20 used according to an embodiment. As can be seen in this case, the individual pores or internal cavities in the metal foam 20, which are advantageously in the form of capillaries, are each connected to at least one of the adjacent internal cavities. This makes it possible for gas which is introduced into the metal foam 20 on one side to emerge on the other side of the metal foam 20. Since the heated gas flows through a multiplicity of small chambers or internal cavities in the metal foam 20, the gas comes into contact with a very large metal surface area. The high thermal conductivity of the metal material of the foam therefore results in effective heat transmission from the switching gas to the metal. The switching gas therefore emerges from the metal foam at a greatly reduced temperature. The cooled-down gas is therefore in a reduced-energy and deionized state.

List of Reference Symbols

1 Circuit breaker

10 Housing

11 Opening

12 Switching area

13 Front wall and rear wall

14 Side walls

15 Cover plates

16 Cover

17 Metal foam

30 Quenching plates

40 Perforated metal sheet

50 Sieve

60 Attachment bolt

What is claimed is:

1. A circuit breaker comprising:
a housing which has at least one opening and having at least one contact pair which are arranged in the housing, wherein the contacts of the contact pair being movable relative to one another in order to open and close a circuit,
an open-pore metal foam, which is electrically isolated from the live parts of the circuit breaker, being arranged between at least one of the contact pairs and at least one housing opening.

2. The circuit breaker according to claim 1,
wherein
quenching plates, on which the metal foam is supported on one side, are arranged in the housing of the circuit breaker.

3. The circuit breaker according to claim 1,
wherein
furthermore at least one perforated metal sheet and/or at least one sieve are/is arranged between the contact pair and the housing opening between which the open-pore metal foam is arranged, in order to reduce the heat of the switching gas.

4. The circuit breaker according to claim 3,
wherein
the metal foam is at least partially connected to the housing and/or to the perforated metal sheet by means of an adhesive connection.

5. The circuit breaker according to claim 1,
wherein
the metal foam is at least partially connected to the housing and/or to the perforated metal sheet by means of a welded or soldered connection.

6. The circuit breaker according to claim 1,
wherein
the metal foam is at least partially connected to the housing and/or to the perforated metal sheet by means of force-fitting clamping.

7. The circuit breaker according to claim 1,
wherein
the metal foam forms a part of the housing surface in the area of the housing opening.

8. The circuit breaker according to claim 1,
wherein
the metal foam which is used is composed of an aluminum-based alloy.

9. The circuit breaker according to claim 1,
wherein
the metal foam which is used is composed of a zinc-based alloy.

10. A method for providing a cooling structure comprising the step of using of an open-pore metal foam based on a zinc alloy or aluminum alloy as a cooling structure for heat dissipation from switching gases which are created in an electrical switching process.

11. A method for providing a circuit breaker comprising the steps of:
Arranging at least one contact pair in a housing which has at least one opening, wherein the contacts of the contact pair being movable relative to one another in order to open and close a circuit,
Arranging an open-pore metal foam, which is electrically isolated from the live parts of the circuit breaker, between at least one of the contact pairs and at least one housing opening.

12. The method according to claim 11,
further comprising the step of arranging quenching plates, on which the metal foam is supported on one side, in the housing of the circuit breaker.

13. The method according to claim 11,
further comprising the step of arranging at least one perforated metal sheet and/or at least one sieve between the contact pair and the housing opening between which the open-pore metal foam is arranged, in order to reduce the heat of the switching gas.

14. The method according to claim 13,
further comprising the step of connecting the metal foam at least partially to the housing and/or to the perforated metal sheet by means of an adhesive connection.

15. The method according to claim 11,
further comprising the step of connecting the metal foam at least partially to the housing and/or to the perforated metal sheet by means of a welded or soldered connection.

16. The method according to claim 11,
further comprising the step of connecting the metal foam at least partially to the housing and/or to the perforated metal sheet by means of force-fitting clamping.

17. The method according to claim 11,
wherein the metal foam forms a part of the housing surface in the area of the housing opening.

18. The method according to claim 11,
wherein the metal foam which is used is composed of an aluminum-based alloy.

19. The method according to claim 11,
wherein the metal foam which is used is composed of a zinc-based alloy.
